(19) United States
(12) Patent Application Publication
(10) Pub. No.: US 2015/0134414 A1
(43) Pub. Date: May 14, 2015

(54) SURVEY DRIVEN CONTENT ITEMS

(71) Applicant: Google Inc., Mountain View, CA (US)

(72) Inventors: Daniel Shaffer, Palo Alto, CA (US); Shreyas Doshi, Palo Alto, CA (US); Dani Suleman, Fremont, CA (US); Lakshmi Kumar Dabbiru, Sunnyvale, CA (US); Varouj Chitilian, Hillsborough, CA (US); Sundeep Jain, Los Altos, CA (US)

(21) Appl. No.: 14/498,446

(22) Filed: Sep. 26, 2014

(30) Foreign Application Priority Data
Nov. 10, 2013 (IL) 229363

(51) Int. Cl. G06Q 30/02; G06F 17/22; G06F 17/30

(52) U.S. Cl. CPC G06Q 30/0254; G06F 17/30525; G06F 17/30386; G06F 17/3053; G06F 17/30887; G06F 17/2235; G06Q 30/0203
USPC 705/7.32

(57) ABSTRACT

Systems and methods for annotating a content item may include determining statistical data concerning the at least one resource, brand, product, or service. A statistic of the statistical data may be associated with a content item associated with the at least one resource, brand, product, or service. A request for a content item may be received from a client device and the content item associated with the statistic of the statistical data may be selected in response to the request. Data to effect presentation of the selected content item and data to effect presentation of an annotation with the selected content item may be served. The annotation may be based, at least in part, on the statistic of the statistical data.

### CROSS-REFERENCE TO RELATED PATENT APPLICATIONS

This application claims priority to and the benefit of Israeli Priority Application 229363, entitled “Survey Driven Content Items”, filed Nov. 10, 2013, and which is incorporated herein by reference in its entirety for all purposes.

### BACKGROUND

In a networked environment, such as the Internet or other networks, first-party content providers can provide information for public presentation on resources, for example webpages, documents, applications, and/or other resources. The first-party content can include text, video, and/or audio information provided by the first-party content providers via, for example, a resource server for presentation on a client device over the Internet. The first-party content may be a webpage requested by the client device or a stand-alone application (e.g., a video game, a chat program, etc.) running on the client device. Additional third-party content can also be provided by third-party content providers for presentation on the client device together with the first-party content provided by the first-party content providers. For example, the third-party content may be a public service announcement or advertisement that appears in conjunction with a requested resource, such as a webpage (e.g., a search result webpage from a search engine, a webpage that includes an online article, a webpage of a social networking service, etc.) or with an application (e.g., an advertisement within a game). Thus, a person viewing a resource can access the first-party content that is the subject of the resource as well as the third-party content that may or may not be related to the subject matter of the resource.

### SUMMARY

Implementations described herein relate to providing annotations with content items. An annotation includes a statistic derived from statistical data that concerns a subject associated with the content item, such as a brand, a product, a website, a service, etc. The statistic may be automatically associated with the content item and data to effect presentation of the content item and the annotation, including the associated statistic, can be served in response to a request from a client device.

One implementation relates to a system for annotating a content item. The system includes one or more processors and a storage device storing instructions that, when executed by the one or more processors, cause the one or more processors to perform several operations. The operations include receiving data from several users in response to a survey concerning a resource, a brand, a product, or a service. The operations further include determining statistical data concerning the resource, brand, product, or service and automatically associating a statistic of the statistical data with a content item associated with the resource, brand, product, or service. The operations also include receiving a request for a content item from a client device, selecting the content item associated with the statistic of the statistical data in response to the request, and serving data to effect presentation of the selected content item and data to effect presentation of an annotation with the selected content item. The annotation is based, at least in part, on the statistic of the statistical data.

Another implementation relates to a method for annotating a content item. The method includes determining statistical data concerning a resource, a brand, a product, or a service based on data from a plurality of users in response to a survey concerning the resource, brand, product, or service. The determination of the statistical data may include parsing the statistical data for a first identifier and matching the parsed first identifier with a second identifier associated with a content item associated with the resource, brand, product, or service. The method still further includes associating a statistic of the statistical data associated with the first identifier with the content item associated with the resource, brand, product, or service in response to the matched parsed first identifier and the second identifier. The method also includes receiving a request for a content item from a client device, selecting the content item associated with the statistic of the statistical data in response to the request, and serving data to effect presentation of the selected content item and data to effect presentation of an annotation with the selected content item. The annotation is based, at least in part, on the statistic of the statistical data.

Yet a further implementation relates to a computer readable storage device storing instructions that, when executed by one or more processors, cause the one or more processors to perform several operations. The operations include determining statistical data concerning a resource, a brand, a product, or a service based on data from a plurality of users in response to a survey concerning the resource, brand, product, or service. The determination of the statistical data may include parsing the statistical data for a first identifier and matching the parsed first identifier with a second identifier associated with a content item associated with the resource, brand, product, or service. The operations further include associating a statistic of the statistical data associated with the first identifier with the content item associated with the resource, brand, product, or service in response to the matched parsed first identifier and the second identifier. The operations also include receiving a request for a content item from a client device, selecting the content item associated with the statistic of the statistical data in response to the request, and serving data to effect presentation of the selected content item and data to effect presentation of an annotation with the selected content item. The annotation is based, at least in part, on the statistic of the statistical data. The operations still further include serving the survey concerning the resource, brand, product, or service to the client device.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram depicting an implementation of a system of providing information via a computer network;

FIG. 2 is a block diagram depicting an implementation of a content item selection system;

FIG. 3A is an overview depicting a content item without an annotation;

FIG. 3B is an overview of the content item of FIG. 3A including an annotation;

FIG. 4 is a flow diagram depicting an implementation of a process for automatically associating a statistic from statistical data with a content item;

FIG. 5 is another flow diagram depicting an implementation of a process for associating a statistic from statistical data with a content item, serving data to effect presentation of the content item and an annotation based on the statistic, and serving a survey to the client device receiving the content item; and

FIG. 6 is a block diagram depicting a general architecture for a computer system that may be employed to implement various elements of the systems and methods described and illustrated herein.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Following below are more detailed descriptions of various concepts related to, and implementations of, methods, apparatuses, and systems for providing information on a computer network. The various concepts introduced above and discussed in greater detail below may be implemented in any of numerous ways, as the described concepts are not limited to any particular manner of implementation. Examples of specific implementations and applications are provided primarily for illustrative purposes.

A computing device (e.g., a client device) can view a resource, such as a web page, via the Internet by communicating with a server, such as a web page server, corresponding to that resource. The resource includes first-party content that is the subject of the resource from a first-party content provider, as well as additional third-party provided content, such as advertisements or other content. In one implementation, responsive to receiving a request to access a web page, a web page server and/or a client device can communicate with a data processing system, such as a content item selection system, to request a content item to be presented with the requested web page. The content item selection system can select a third-party content item and provide data to effect presentation of the content item with the requested web page on a display of the client device. In some instances, the content item is selected and served with a resource associated with a search query response. For example, a search engine may return search results on a search results web page and may include third-party content items related to the search query in one or more content item slots of the search results web page.

The computing device (e.g., a client device) may also be used to view or execute an application, such as a mobile application. The application may include first-party content that is the subject of the application from a first-party content provider and may also include additional third-party provided content, such as advertisements or other content. In one implementation, responsive to use of the application, a resource server and/or a client device can communicate with a data processing system, such as a content item selection system, to request a content item to be presented with a user interface of the application and/or otherwise. The content item selection system can select a third-party content item and provide data to effect presentation of the content item with the application on a display of the client device.

In some instances, a device identifier is associated with the client device. The device identifier may include a randomized number associated with the client device to identify the device during subsequent requests for resources and/or content items. In some instances, the device identifier is configured to store and/or cause the client device to transmit information related to the client device to the content item selection system and/or resource server (e.g., a web browser type, an operating system, prior resource requests, prior content item requests, etc.).

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

A third-party content provider, when providing third-party content items for presentation with requested resources via the Internet or other network, may utilize a content item management service to control or otherwise influence the selection and serving of the third-party content items. For instance, a third-party content provider may specify selection criteria (such as keywords) and corresponding bid values that are used in the selection of the third-party content items. The bid values may be utilized by the content item selection system in an auction to select and serve content items for presentation with a resource. For example, a third-party content provider may place a bid in the auction that corresponds to an agreement to pay a certain amount of money if a user interacts with the provider's content item (e.g., the provider agrees to pay $3 if a user clicks on the provider's content item). In other examples, a third-party content provider may place a bid in the auction that corresponds to an agreement to pay a certain amount of money if the content item is selected and served (e.g., the provider agrees to pay $0.005 each time a content item is selected and served or the provider agrees to pay $0.05 each time a content item is selected or clicked). In some instances, the content item selection system uses content item interaction data to determine the performance of the third-party content provider's content items. For example, users may be more inclined to click on third-party content items on certain webpages over others. Accordingly, auction bids to place the third-party content items may be higher for high-performing webpages, categories of webpages, and/or other criteria, while the bids may be lower for low-performing webpages, categories of webpages, and/or other criteria.

In some instances, one or more performance metrics for the third-party content items may be determined and indications of such performance metrics may be provided to the third-party content provider via a user interface for the content item management account. For example, the performance metrics may include a cost per impression (CPI) or cost per thousand impressions (CPM), where an impression may be counted, for example, whenever a content item is selected to be served for presentation with a resource. In some instances, the performance metric may include a click-through rate (CTR), defined as the number of clicks on the content item divided by the number of impressions. Still other performance metrics, such as cost per action (CPA) (where an action may be clicking on the content item or a link therein, a purchase of a product, a referral of the content item, etc.), conversion rate (CVR), cost per click-through (CPC) (counted when a content item is clicked), cost per sale (CPS), cost per lead (CPL), effective CPM (eCPM), and/or other performance metrics may be used.

In some instances, a webpage or other resource (such as, for example, an application) includes one or more content item slots in which a selected and served third-party content item may be displayed. The code (e.g., JavaScript®, HTML, etc.) defining a content item slot for a webpage or other resource may include instructions to request a third-party content item from the content item selection system to be presented with the webpage. In some implementations, the code may include an image request having a content item request URL that may include one or more parameters (e.g., /page/contentitem?devid=abc123&devnfo=A34r0). Such parameters may, in some implementations, be encoded strings such as “devid=abc123” and/or “devnfo=A34r0.”

The selection of a third-party content item to be served with the resource by a content item selection system may be based on several influencing factors, such as a predicted click through rate (pCTR), a predicted conversion rate (pCVR), a bid associated with the content item, etc. Such influencing factors may be used to generate a value, such as a score, against which other scores for other content items may be compared by the content item selection system through an auction.

During an auction for a content item slot for a resource, such as a webpage, several different types of bid values may be utilized by third-party content providers for various third-party content items. For example, an auction may include bids based on whether a user clicks on the third-party content item, whether a user performs a specific action based on the presentation of the third-party content item, whether the third-party content item is selected and served, and/or other types of bids. For example, a bid based on whether the third-party content item is selected and served may be a lower bid (e.g., $0.005) while a bid based on whether a user performs a specific action may be a higher bid (e.g., $5). In some instances, the bid may be adjusted to account for a probability associated with the type of bid and/or adjusted for other reasons. For example, the probability of the user performing the specific action may be low, such as 0.2%, while the probability of the selected and served third-party content item may be 100% (e.g., the selected and served content item will occur if it is selected during the auction, so the bid is unadjusted). Accordingly, a value, such as a score or an normalized value, may be generated to be used in the auction based on the bid value and the probability or another modifying value. In the prior example, the value or score for a bid based on whether the third-party content item is selected and served may be $0.005*1.00=0.005 and the value or score for a bid based on whether a user performs a specific action may be $5*0.002=0.01. To maximize the income generated, the content item selection system may select the third-party content item with the highest value from the auction. In the foregoing example, the content item selection system may select the content item associated with the bid based on whether the user performs the specific action due to the higher value or score associated with that bid.

Once a third-party content item is selected by the content item selection system, data to effect presentation of the third-party content item on a display of the client device may be provided to the client device using a network.

In some implementations, it may useful to provide statistical data with the served third-party content item. Presentation of statistics with the third-party content item, such as an advertisement, may be in the form of an annotation to automatically provide useful information to users to help them make better decisions with respect to the advertisement. Such “trust annotations” seek to help users understand whether a given advertiser or domain is “trustworthy” based on automated signals and are served in response to a user query with a corresponding user interface. In other implementations, it may be usedul to provide statistical data with other content items, such as organic search results.

The system may be configured to recognize one or more identifiers of the advertisement, such as an identifier for an entity of BigRetailer and/or an identifier for a product of Widgets, and may be configured to retrieve and serve an annotation that includes statistical information for the identifiers, such as BigRetailer and/or Widgets in the present example, that is received in response to surveys provided to other users or other third-parties. Such other users or other third-parties may be independent of the third-party content provider or advertiser such that the third-party content provider or advertiser does not have influence over the details of the annotation. That is, the annotations may be automatic, which means that the third-party content provider or advertiser does not provide any input. This independence may reduce or substantially prevent a third-party content provider or advertiser from influencing or “gaming” the statistical information provided with the content item, thereby enhancing the trust of a user in the annotation provided with the content item. In some implementations, a threshold value for the statistic of the annotation may be used such that annotations are only provided if the statistic equals or exceeds the threshold value. Accordingly, in some implementations an annotation may be omitted if the statistical information is negative. In other implementations, the third-party content provider or advertiser may elect not to include the annotation.

An annotation may include or consist of one or more attributes (i.e., the particular aspect about which the statistic is concerned) about an entity associated with the content item, such as a domain, a landing page, a brand, or a product or service being offered. The entity defines a context for the annotation, which could be further limited by a category or vertical (e.g., an annotation is only shown for X Brand for content items for Y category or vertical) or with a query whitelist (e.g., for only certain enumerated queries). In some instances, the annotation may be triggered only for content items where a domain of a click-through link of the content item matches a context domain for the statistic. For example, an annotation associated with the domain BigRetailer.com (e.g., 88% of BigRetailer customers report being ‘very satisfied’ with their purchase from BigRetailer.com) may only be added for content items having a link URL to BigRetailer.com. In another example, an annotation associated with a product, such as Widgets, may cause the annotation to trigger only when the product is present in the advertisement. In still other example, an annotation based on a brand name may be used when the brand is the subject of the advertisement. In yet a further example, an annotation associated with an organic search result, such as a website, may be used when the content item is a website corresponding to the organic search result.

In some further implementations, the matches of domains, products, brands, etc. may be further limited based on matching categories or verticals and matching all or a portion of a query. That is, for statistical information derived from a survey about GHI car insurance, an annotation may be matched and served with the content item only for content items that are for a domain for GHI.com, include the subject of car insurance, and when the query indicates a request for information about car insurance.

Such annotations provide users value by telling users what kinds of decisions others in their position have made and/or think about the entity while also limiting the influence a content provider, such as an advertiser, may have regarding the underlying statistical data.

While the foregoing has provided an overview of providing annotations with content items, more specific examples and systems to implement such systems and methods will now be described.

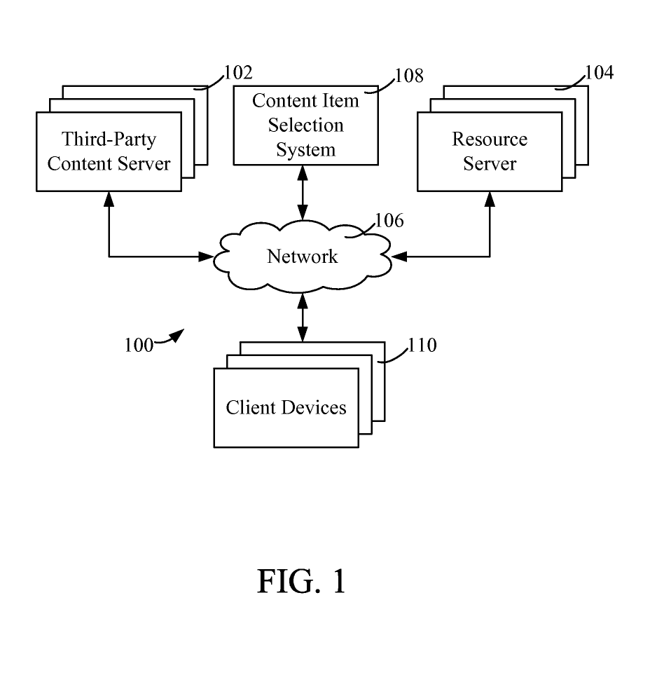

FIG. 1 is a block diagram of an implementation of a system 100 for providing information via at least one computer network such as the network 106. The network 106 may include a local area network (LAN), wide area network (WAN), a telephone network, such as the Public Switched Telephone Network (PSTN), a wireless link, an intranet, the Internet, or combinations thereof. The system 100 can also include at least one data processing system, such as a content item selection system 108. The content item selection system 108 can include at least one logic device, such as a computing device having a data processor, to communicate via the network 106, for example with a resource server 104, a client device 110, and/or a third-party content server 102. The content item selection system 108 can include one or more data processors, such as a content placement processor, configured to execute instructions stored in a memory device to perform one or more operations described herein. In other words, the one or more data processors and the memory device of the content item selection system 108 may form a processing module. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, C, C++, C#, Java®, JavaScript®, Perl®, HTML, XML, Python®, and Visual Basic®. The processor may process instructions and output data to effect presentation of one or more content items to the resource server 104 and/or the client device 110. In addition to the processor, the content item selection system 108 may include one or more databases configured to store data. The content item selection system 108 may also include an interface configured to receive data via the network 106 and to provide data from the content item selection system 108 to any of the other devices on the network 106. The content item selection system 108 can include a server, such as an advertisement server or otherwise.

The client device 110 can include one or more devices such as a computer, laptop, desktop, smart phone, tablet, personal digital assistant, set-top box for a television set, a smart television, or server device configured to communicate with other devices via the network 106. The device may be any form of portable electronic device that includes a data processor and a memory. The memory may store machine instructions that, when executed by a processor, cause the processor to perform one or more of the operations described herein. The memory may also store data to effect presentation of one or more resources, content items, etc. on the computing device. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, ActionScript®, C, C++, C#, HTML, Java®, JavaScript®, Perl®, Python®, Visual Basic®, and XML.

The client device 110 can execute a software application (e.g., a web browser or other application) to retrieve content from other computing devices over network 106. Such an application may be configured to retrieve first-party content from a resource server 104. In some cases, an application running on the client device 110 may itself be first-party content (e.g., a game, a media player, etc.). In one implementation, the client device 110 may execute a web browser application which provides a browser window on a display of the client device. The web browser application that provides the browser window may operate by receiving input of a uniform resource locator (URL), such as a web address, from an input device (e.g., a pointing device, a keyboard, a touch screen, or another form of input device). In response, one or more processors of the client device executing the instructions from the web browser application may request data from another device connected to the network 106 referred to by the URL address (e.g., a resource server 104). The other device may then provide web page data and/or other data to the client device 110, which causes visual indicia to be displayed by the display of the client device 110. Accordingly, the browser window displays the retrieved first-party content, such as web pages from various websites, to facilitate user interaction with the first-party content.

The resource server 104 can include a computing device, such as a server, configured to host a resource, such as a web page or other resource (e.g., articles, comment threads, music, video, graphics, search results, information feeds, etc.). The resource server 104 may be a computer server (e.g., a file transfer protocol (FTP) server, file sharing server, web server, etc.) or a combination of servers (e.g., a data center, a cloud computing platform, etc.). The resource server 104 can provide resource data or other content (e.g., text documents, PDF files, and other forms of electronic documents) to the client device 110. In one implementation, the client device 110 can access the resource server 104 via the network 106 to request data to effect presentation of a resource of the resource server 104.

One or more third-party content providers may have third-party content servers 102 to directly or indirectly provide data for third-party content items to the content item selection system 108 and/or to other computing devices via network 106. The content items may be in any format that may be presented on a display of a client device 110, for example, graphical, text, image, audio, video, etc. The content items may also be a combination (hybrid) of the formats. The content items may be banner content items, interstitial content items, pop-up content items, rich media content items, hybrid content items, Flash® content items, cross-domain iframe content items, etc. The content items may also include embedded information such as hyperlinks, metadata, links, machine-executable instructions, annotations, etc. In some instances, the third-party content servers 102 may be integrated into the content item selection system 108 and/or the data for the third-party content items may be stored in a database of the content item selection system 108.

In one implementation, the content item selection system 108 can receive, via the network 106, a request for a content item to present with a resource. The received request may be received from a resource server 104, a client device 110, and/or any other computing device. The resource server 104 may be owned or ran by a first-party content provider that may include instructions for the content item selection system 108 to provide third-party content items with one or more resources of the first-party content provider on the resource server 104. In one implementation, the resource may include a web page. The client device 110 may be a computing device operated by a user (represented by a device identifier), which, when accessing a resource of the resource server 104, can make a request to the content item selection system 108 for content items to be presented with the resource, for instance. The content item request can include requesting device information (e.g., a web browser type, an operating system type, one or more previous resource requests from the requesting device, one or more previous content items received by the requesting device, a language setting for the requesting device, a geographical location of the requesting device, a time of a day at the requesting device, a day of a week at the requesting device, a day of a month at the requesting device, a day of a year at the requesting device, etc.) and resource information (e.g., URL of the requested resource, one or more keywords of the content of the requested resource, text of the content of the resource, a title of the resource, a category of the resource, a type of the resource, etc.). The information that the content item selection system 108 receives can include a HyperText Transfer Protocol (HTTP) cookie which contains a device identifier (e.g., a random number) that represents the client device 110. In some implementations, the device information and/or the resource information may be appended to a content item request URL (e.g., contentitem.item/page/contentitem?devid=abc123&devnfo=A34r0). In some implementations, the device information and/or the resource information may be encoded prior to being appended the content item request URL. The requesting device information and/or the resource information may be utilized by the content item selection system 108 to select third-party content items to be served with the requested resource and presented on a display of a client device 110.

In some instances, a resource of a resource server 104 may include a search engine feature. The search engine feature may receive a search query (e.g., a string of text) via an input feature (an input text box, etc.). The search engine may search an index of documents (e.g., other resources, such as web pages, etc.) for relevant search results based on the search query. The search results may be transmitted as a second resource to present the relevant search results, such as a search result web page, on a display of a client device 110. The search results may include web page titles, hyperlinks, etc. In some instances, each search result may be a content item. One or more third-party content items may also be presented with the search results in a content item slot of the search result web page. Accordingly, the resource server 104 and/or the client device 110 may request one or more content items from the content item selection system 108 to be presented in the content item slot of the search result web page. The content item request may include additional information, such as the user device information, the resource information, a quantity of content items, a format for the content items, the search query string, keywords of the search query string, information related to the query (e.g., geographic location information and/or temporal information), etc. In some implementations, a delineation may be made between the search results and the third-party content items to avert confusion.

In some implementations, the third-party content provider may manage the selection and serving of content items by content item selection system 108. For example, the third-party content provider may set bid values and/or selection criteria via a user interface that may include one or more content item conditions or constraints regarding the serving of content items. A third-party content provider may specify that a content item and/or a set of content items should be selected and served for user devices 110 having device identifiers associated with a certain geographic location or region, a certain language, a certain operating system, a certain web browser, etc. In another implementation, the third-party content provider may specify that a content item or set of content items should be selected and served when the resource, such as a web page, document, etc., contains content that matches or is related to certain keywords, phrases, etc. The third-party content provider may set a single bid value for several content items, set bid values for subsets of content items, and/or set bid values for each content item. The third-party content provider may also set the types of bid values, such as bids based on whether a user clicks on the third-party content item, whether a user performs a specific action based on the presentation of the third-party content item, whether the third-party content item is selected and served, and/or other types of bids.

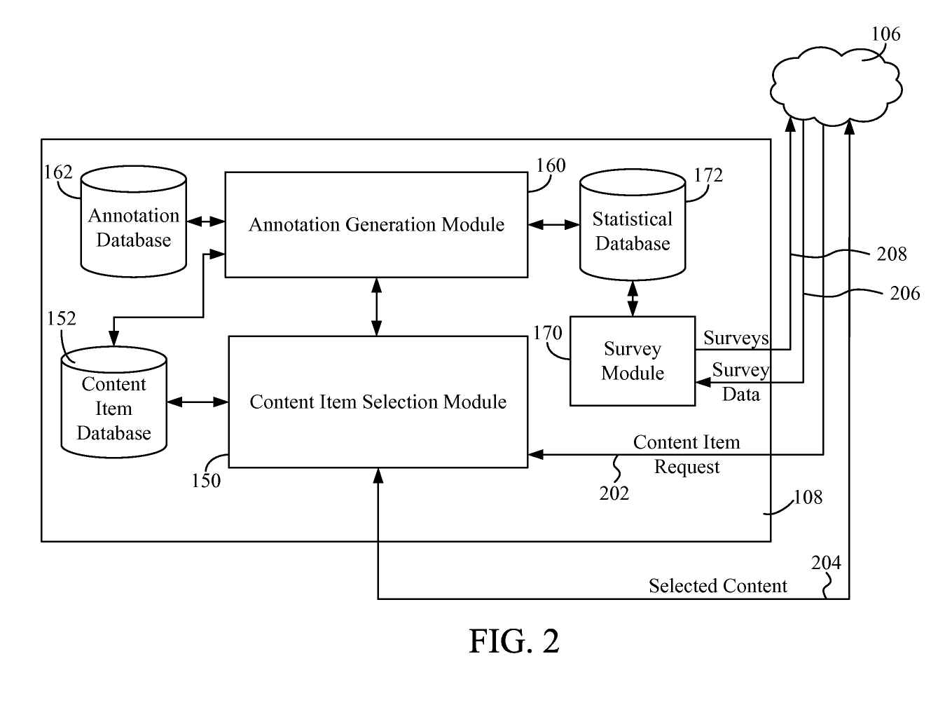

While the foregoing has provided an overview of a system 100 for selecting and serving content items to client devices 110, a more detailed implementation of the content item selection system 108 will now be described in reference to FIG. 2. The content item selection system 108 includes a content item selection module 150, an annotation generation module 160, a survey module 170, a content item database 152, and a statistical database 172. In some implementations, an annotation database 162 may be used to store annotations generated by the annotation generation module 160. Such annotations may be accessible by the content item selection module 150 or another module of the content item selection system 108 to retrieve previously generated and associated annotations for serving with a selected content item.

The content item selection module 150 is configured to receive a content item request 202 via the network 106. A client device, such as the client device 110 of FIG. 1, or a resource server, such as resource server 104, may send the content item request 202 to the content item selection system 108 via the network 106. The content item selection module 150 is configured to perform an auction to select a third-party content item, such as a third-party content item stored in the content item database 152, and to transmit data to effect presentation of the selected third-party content item 204 in response to the content item request 202. As will be discussed in greater detail below, the data transmitted in response to the content item request 202 may also include an annotation to be associated with the selected third-party content item.

The survey module 170 is configured to output surveys 208 to client devices to several users in the form of a survey concerning a subject or entity, such as at least one of a resource, a brand, a product, or a service. Interesting entities (e.g., brands, products, companies, domains, websites, etc.) and attributes (future purchase intent, previous purchase satisfaction, reputation, etc.) may be identified, either manually or automatically, and one or more surveys may be generated for such entities assess the various attributes of the entity or entities. In some implementations, the automatic identification of one or more surveys to generate may include determining the subject matter of recent important topics, such as the subjects trending in recent news articles, social networking websites (e.g., through the use of hashtags, etc.), etc.

The survey module 170 is further configured to receive data 206 from the several users in response to the survey and may store the outputted data 206 in the statistical database 172. In some implementations, the survey module 170 and/or the statistical database 172 may be included in or be an entirely separate system from the content item selection system 108. The statistical database 172 may store each response to each survey as individual records in the statistical database 172 and/or the statistical database 172 may store an aggregate record of the responses. Each record may include the queries and the associated data. For example, a survey may include the query “Will you shop at BigRetailer for a widget in the next 6 months?” and the associated data, such as 88% of respondents indicated “Yes.” In some implementations, the survey may include a filter question, such as “Do you intend to purchase a widget in the next 6 months?” followed by the actual question of “Will you shop at BigRetailer?,” which is presented only if the user expects to be in the market for widgets. In some implementations, the queries may be reduced to keywords or other identifiers, such as “BigRetailer,” “widget,” “shop,” “next,” and “6 months.” The query addresses an attribute (e.g., context) concerning the subject or entity. In the foregoing example, the attribute is shopping for a widget at the subject or entity in the next 6 months. The associated data may include a percentage value for the query for all the users surveyed, such as 88% of respondents indicated “Yes.”

In some implementations, the survey module 170 may be configured to serve a survey concerning the subject or entity, such as at least one resource, brand, product, or service, to a client device after the client device has been served data to effect presentation of a content item with an annotation for the subject or entity, such as the resource, brand, product, or service. The survey module 170 may receive data from the client device in response to the served survey concerning the subject or entity, such as the resource, brand, product, or service, and may determine updated statistical data concerning the subject or entity, such as the resource, brand, product, or service, based, at least in part, on received data from the client device. The updated statistical data may then be stored in the statistical database 172. As will be described in greater detail below, if a second request for a content item is received from a second client device, then data to effect presentation of an updated annotation for the content item may be served to a client device based, at least in part, on the updated statistic of the updated statistical data.

The annotation generation module 160 is configured to access the statistical database 172 to determine statistical data that corresponds to a subject or entity, such as a resource, a brand, a product, or a service. The determination of the statistical data may be further limited, such as a brand further limited by a product, such that the statistical data must match the additional limitation, such as matching both the brand and product. In another implementation, the statistical data may be further limited by a category or vertical such that the statistical data must match the subject or entity and the category or vertical, such as Brand X and category of auto repair or company GEH and category of car insurance. The subject or entity, additional limitations, and/or category or vertical may be received by the annotation generation module 160 from the content item selection module 150 in response to the selection of a content item responsive to a content item request 202 or the subject or entity, additional limitations, and/or category or vertical may be received by the annotation generation module 160 from the content item selection module 150 independent of a content item request (e.g., to pre-generate annotations for one or more content items).

The annotation generation module 160 uses the determined and retrieved statistical data from the statistical database 172 to generate an annotation for a content item. In some implementations, the annotation generation module 160 automatically associates a statistic of the statistical data with a content item associated with the subject or entity, such as the resource, brand, product, or service. The automatic association may include linking a pointer for the data in the statistical database 172 with the content item associated with the subject or entity. Accordingly, when the corresponding data is updated in the statistical database 172, such as when additional survey response data is received 206, then the statistic associated with the content item will retrieve the updated data. In some implementations, the association of the statistic of the statistical data with the content item may include the generation of an annotation that is based on the statistic (e.g., the data associated with a survey query). The statistic may be further based on an attribute (e.g., all or a portion of the query). The generated annotation may be stored in an annotation database 162 such that the annotation may be subsequently retrieved without being generated again.

In some implementations, the annotation generation module 160 may be configured to parse the statistical data stored in the statistical database 172 for a first identifier associated with a statistic and match the first identifier parsed from the statistical data with a second identifier associated with a content item. That is, the automatic associating of the statistic of the statistical data with the content item associated with a subject or entity, such as at least one resource, brand, product, or service, is in response to the parsed first identifier associated with the statistic matching a second identifier associated with content item. Thus, the annotation generation module 160 may be configured to match the queries and data from surveys with content items by matching identifiers of each. In some implementations, a set of identifiers may be matched, such as matching a brand identifier and a product identifier for a content item with a first identifier and a second identifier associated with a statistic of the statistical data. That is, the annotation generation module 160 may be configured to match a content item for BigRetailer for the product named Widget with the statistical data for BigRetailer about the product named Widget. The annotation generation module 160 may be further configured to utilize other identifiers or filters to further refine the determined or retrieved statistical data of the statistical database 172 (e.g., by matching categories or verticals, by matching a domain in a link URL of a content item with a domain of a query, by matching services, by matching companies, by matching a landing page, etc.).

As described above, in some implementations, a survey concerning the subject or entity, such as at least one resource, brand, product, or service, may be served to a client device after the client device has been served data to effect presentation of a content item with an annotation for the subject or entity, such as the resource, brand, product, or service. Data received from the client device in response to the served survey concerning the at least one resource, brand, product, or service may be used to update one or more statistics of the statistical data. In some implementations, the annotation for a content item may automatically update, such as through the use of a pointer to the now-updated statistic of the updated statistical data. In some implementations, the annotation generation module 170 may be configured to generate an updated annotation based, at least in part, on the updated statistic. In some implementations, the annotation generation module 160 may be integrated into the content item selection module 150.

The content item selection module 150 is configured to receive a content item request 202 via the network 106, select a content item, and serve data to effect presentation of the selected content item 204 in response to the content item request. The content item selection module 150 is configured to perform an auction to select a third-party content item, such as a third-party content item stored in the content item database 152, and to transmit data to effect presentation of the selected third-party content item 204 in response to the content item request 202. The content item selection module 150 may also be configured to send one or more identifiers to the annotation generation module 160 such that the annotation generation module 160 may determine and/or retrieve the relevant statistical data from the statistical database 172. The one or more identifiers may include a subject or entity, additional limitations, and/or category or vertical. The one or more identifiers may be determined based on a third-party content item selected as a result of the auction. That is, in some implementations a third-party content item may be selected to be served by the content item selection module 150.

The content item selection module 150 may determine one or more identifiers based on the selected content item and/or the content item request 202. In an implementation, the one or more identifiers may be based on a search query of the content item request 202, such as query of “car insurance,” and the selected content item, such as a content item for GEH car insurance having a link URL with a domain of GEH.com. Thus, the one or more identifiers that may be sent to the annotation generation module 160 may include a brand of “GEH,” a domain of “GEH.com,” and a category or vertical of “car insurance.” The annotation generation module 160 determines and/or retrieves statistical data from the statistical database 172 that matches the brand of “GEH,” the domain of “GEH.com,” and the category or vertical of “car insurance.” In some implementations, the statistical data may include several statistics. The several statistics may, in some implementations, be ranked (e.g., based on the value of the statistic) and the highest statistic is used for the annotation. In other implementations, a random statistic may be selected. An annotation is generated based on a statistic of the data of the statistical data. In some implementations, the statistic used to generate the annotation may be further based on an attribute concerning the subject or entity, such as a resource, brand, product, or service. The attribute may be associated with a user behavior, such as a future user behavior of purchasing a certain product within a period of time. In some implementations, the annotation generation module 160 may simply retrieve a generated attribute associated with the selected content item from the annotation database 162.

In some implementations, the statistics associated with content items may be utilized by the content item selection module 150 to modify a ranking of the content item based, at least in part, on the statistic. That is, a statistic for one or more content items in the auction may be determined by the annotation generation module 160 and the content item selection module 150 may use the statistic for each content item in a scoring function. Thus, a content item having a high value for a statistic, such as a statistic of 88% for consumer satisfaction, may have a ranking modified by an increase in a resulting score while a content item having a lower value for a statistic, such as a statistic of 54% for consumer satisfaction, may have a ranking modified by a decrease in a resulting score. Thus, in some implementations, the statistic may be retrieved and used by the content item selection module 150 during the auction to modify a ranking of a content item. In further implementations, the statistics associated with content items may be utilized by the content item selection module 150 to modify a price charged for the content item based, at least in part, on the statistic. In still further implementations, the statistics associated with content items may be utilized by the content item selection module 150 to modify both a ranking and a price charged for the content item based, at least in part, on the statistic. The modification of the ranking, pricing, and/or both the ranking and pricing may be independent of presenting an annotation with a selected content item.

The content item selection module 150 is also configured to transmit data to effect presentation of the selected content item 204 and data to effect presentation of the annotation based on the statistic in response to the content item request 202.

In some implementations, a survey concerning the subject or entity, such as at least one resource, brand, product, or service, may be served to a client device by the survey module 170 after the client device has been served data to effect presentation of a content item 204 with an annotation for the subject or entity, such as the resource, brand, product, or service. Data received from the client device in response to the served survey concerning the at least one resource, brand, product, or service may be used to update one or more statistics of the statistical data. In some implementations, the annotation for a content item may automatically update, such as through the use of a pointer to the now-updated statistic of the updated statistical data, or the annotation generation module 170 generate an updated annotation based, at least in part, on the updated statistic. In some implementations, the content item selection module 150 may receive a second request for a content item from a second client device. The second client device may be the same as the original client device or may be a different client device. The content item selection module 150 may be configured to select the content item associated with an updated statistic of the updated statistical data in response to the request. The selection of the content item may result from the content item being selected again during an auction by the content item selection module 150. The content item selection module 150 may be configured to serve data to effect presentation of the selected content item and data to effect presentation of an updated annotation based, at least in part, on the updated statistic of the updated statistical data.

In some implementations, the content item may be an organic search result, such as a result shown on a landing page of a search engine website in response to a search query. The content item selection module 150 may be configured to use the statistical data to provide annotations with the organic search results and/or to modify the ranking of the organic search results.

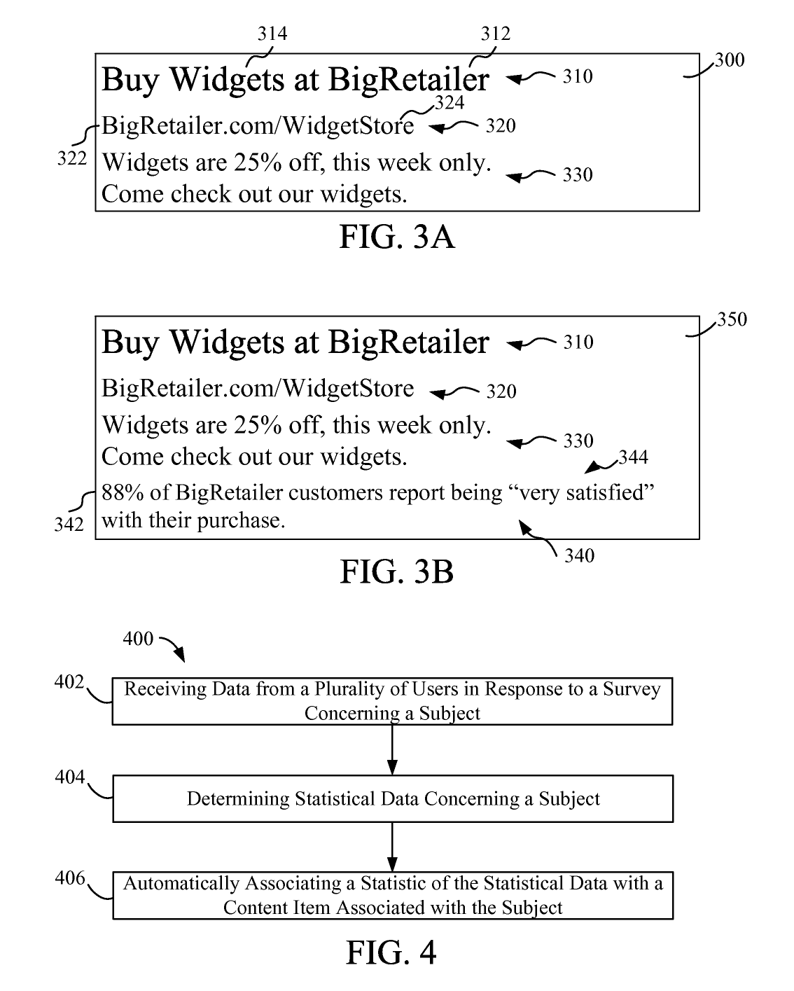

While the foregoing description has described a system 100 for providing information that includes a content item selection system 108 and modules and configurations for the content item selection system 108, examples of a content item having an included annotation will now be described in reference to FIGS. 3A-3B. FIG. 3A depicts an example content item 300. The content item 300 includes a title portion 310, a link portion 320, and a description portion 330. In the example shown, the title portion 310 includes a brand identifier 312 and a product identifier 314. In some implementations, the content item selection system 150 of FIG. 2 may be configured to parse textual data from the content item 300, such as the brand identifier 312 and the product identifier 314, to be used by the annotation generation module 160 in determining and/or retrieving statistics for an annotation for the content item 300. In other implementations, the content item selection system 150 of FIG. 2 may determine a brand identifier and/or product identifier from metadata of the content item and/or from the content item provider providing an indication of the brand and/or product with the content item 300 (e.g., through via a user interface for the content item management account), such as for non-textual content items.

The link portion 320 includes text of a link URL for the content item 300. In the example shown, the link portion 320 includes a domain identifier 322 and a landing page identifier 324. In some implementations, the content item selection system 150 of FIG. 2 may be configured to parse textual data from the content item 300, such as the domain identifier 322 and the landing page identifier 324, to be used by the annotation generation module 160 in determining and/or retrieving statistics for an annotation for the content item 300. In other implementations, the content item selection system 150 of FIG. 2 may determine a brand identifier and/or product identifier from metadata of the content item (e.g., from a link URL included with the content item) and/or from the content item provider providing an indication of the domain and/or landing page with the content item 300 (e.g., through via a user interface for the content item management account), such as for non-textual content items.

The content item 300 further includes a description portion 330, which may include desired textual and/or visual information to be conveyed to a viewer of the content item.

FIG. 3B depicts a modified content item 350 based on the content item 300 of FIG. 3A and including an annotation 340. In the present example, the annotation 340 is incorporated into the content item 350, though other ways to present the annotation 340 may be utilized. For example, the annotation 340 may be displayed when a mouse rollover or hover action occurs, when a user selects an indicator (e.g., “More Information”), or included below the content item 310. The annotation 340 includes a statistic 342 and a context portion 344. The statistic 342 displays the data from the statistical data stored in the statistical database 172 and transmitted by the content item selection module 150 to effect presentation of the annotation with the content item. The context portion 344 may be derived from a query from a survey associated with the statistic 342. Examples of other annotations 340 may include: 77% of future Widget buyers intend to shop at BigRetailer, 65% of consumers intend to shop at BigRetailer this holiday season, 88% of BigRetailer customers report being ‘very satisfied’ with their purchase, Customer Satisfaction [****] Good Value [*****], BigRetailer is rated #1 among retailers for return policy, etc.

FIG. 4 depicts an implementation of a process 400 for automatically associating a statistic from statistical data with a content item. The process 400 may include receiving data from a plurality of users in response to a survey concerning subject (block 402), such as a resource, a brand, a product, or a service. The data may be received by a survey module that aggregates the received data and stores the aggregated data in a statistical database. The received data may be stored in a data structure, such as an array or table, that includes a query, such as a query from the survey, and a data value for the query, such as values for the responses to the query or an aggregate statistic value. In some implementations, the data structure may also include one or more identifiers associated with the corresponding data value. Such identifiers may, in some implementations, may be parsed from the query.

The process 400 includes determining statistical data concerning a subject (block 404). The subject may be at least one of a resource (e.g., a website), a brand, a product, or a service. In some implementations, determining the statistical data concerning a subject may include matching one or more received identifiers with one or more identifiers associated with a data value, such as a statistic, of the statistical data stored in the statistical database. In some implementations, the one or more identifiers associated with a data value may be parsed from a query associated with the data value, such as a query from a survey served to several users of client devices. In some implementations, several data values of the statistical data may be identified as matching the one or more identifiers. In some implementations, a set of identifiers may be matched, such as matching a brand identifier and a product identifier for a content item with a first identifier and a second identifier associated with a statistic of the statistical data. That is, a set of identifiers for a content item for BigRetailer for the product named Widget (e.g., an identifier for a brand “BigRetailer” and an identifier for a product name of “Widget”) may be matched with the statistical data having a brand identifier of BigRetailer and a product name od Widget. In some implementations, other identifiers or filters to further refine the determined or retrieved statistical data from the statistical database (e.g., by matching categories or verticals, by matching a domain in a link URL of a content item with a domain of a query, by matching services, by matching companies, by matching a landing page, etc.).

The process 400 may further include automatically associating a statistic of the statistical data with a content item associated with the subject (block 406). In some implementations, the association of the statistic with the content item associated with the subject or entity, such as a resource, brand, product, or service, may be done in response to a request for a content item or may be independent of a request for a content item (e.g., offline or at a time other than when a content item is requested). The automatic association of the statistic with the content item associated with the subject or entity may include associating an identifier for the statistic, such as a pointer for the data, with the content item. The statistic may be a percentage of all users surveyed that agree with a query. In some implementations, the statistic may be further based on an attribute (i.e., the particular aspect about which the statistic is concerned, such as a future purchase intent, a previous purchase satisfaction, a reputation, etc.) concerning the subject or entity, such as a resource, brand, product, or service. The attribute may be associated with a user behavior, such as a future user behavior.

In some implementations, the automatic associating of the statistic with the content item associated with the subject or entity, such as at least one resource, brand, product, or service, may be in response to a parsed first identifier associated with the statistic matching a second identifier associated with the content item. In some implementations, the parsed first identifier may be a domain name associated with the statistic and the second identifier may be a domain name contained in a link URL of the content item. In further implementations, the parsed first identifier may be a product name associated with the statistic and the second identifier is a product name associated with the content item. In still further implementations, the parsed first identifier may be a resource, such as a website or landing page, and the second identifier may be a website or landing page of a link URL of the content item. In further implementations, the parsed first identifier may be a brand name and the second identifier may be brand name associated with the content item. In further implementations, the parsed first identifier may be a service and the second identifier may be service associated with the content item.

In some implementations, an annotation may be generated using the statistic for the associated content item. As discussed herein, the data to effect display of the annotation may be served with the content item to a client device. In some instances, the generated annotation may be stored in an annotation database for retrieval in response a subsequent content item request for which the content item is selected.

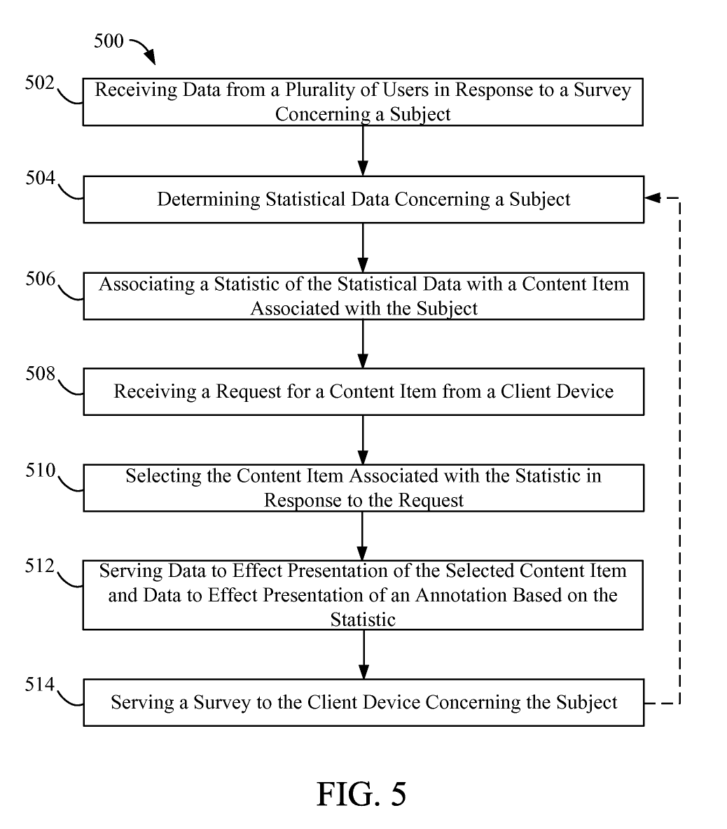

FIG. 5 depicts an implementation of a process 500 for associating a statistic from statistical data with a content item and serving data to effect presentation of the content item and an annotation based on the statistic. The process 500 may include receiving data from a plurality of users in response to a survey concerning a subject (block 502), such as a resource, a brand, a product, or a service. The data may be received by a survey module that aggregates the received data and stores the aggregated data in a statistical database. The received data may be stored in a data structure, such as an array or table, that includes a query, such as a query from the survey, and a data value for the query, such as values for the responses to the query or an aggregate statistic value. In some implementations, the data structure may also include one or more identifiers associated with the corresponding data value. Such identifiers may, in some implementations, may be parsed from the query. In some implementations, the process 500 may also include the prior step of serving the survey concerning the subject, such as at least one resource, brand, product, or service, to a client device of a user of the plurality of users or to several client devices of several users of the plurality of users.

The process 500 includes determining statistical data concerning a subject (block 504). The subject may be at least one of a resource (e.g., a website), a brand, a product, or a service. In some implementations, determining the statistical data concerning a subject may include matching one or more received identifiers with one or more identifiers associated with a data value, such as a statistic, of the statistical data stored in the statistical database. In some implementations, the one or more identifiers associated with a data value may be parsed from a query associated with the data value, such as a query from a survey served to several users of client devices. In some implementations, several data values of the statistical data may be identified as matching the one or more identifiers. In some implementations, a set of identifiers may be matched, such as matching a brand identifier and a product identifier for a content item with a first identifier and a second identifier associated with a statistic of the statistical data. That is, a set of identifiers for a content item for BigRetailer for the product named Widget (e.g., an identifier for a brand “BigRetailer” and an identifier for a product name of “Widget”) may be matched with the statistical data having a brand identifier of BigRetailer and a product name od Widget. In some implementations, other identifiers or filters to further refine the determined or retrieved statistical data from the statistical database (e.g., by matching categories or verticals, by matching a domain in a link URL of a content item with a domain of a query, by matching services, by matching companies, by matching a landing page, etc.).

The process 500 may further include associating a statistic of the statistical data with a content item associated with the subject (block 506). In some implementations, the association of the statistic with the content item associated with the subject or entity, such as a resource, brand, product, or service, may be done in response to a request for a content item or may be independent of a request for a content item (e.g., offline or at a time other than when a content item is requested). The automatic association of the statistic with the content item associated with the subject or entity may include associating an identifier for the statistic, such as a pointer for the data, with the content item. The statistic may be a percentage of all users surveyed that agree with a query. In some implementations, the statistic may be further based on an attribute (i.e., the particular aspect about which the statistic is concerned, such as a future purchase intent, a previous purchase satisfaction, a reputation, etc.) concerning the subject or entity, such as a resource, brand, product, or service. The attribute may be associated with a user behavior, such as a future user behavior.

In some implementations, the automatic associating of the statistic with the content item associated with the subject or entity, such as at least one resource, brand, product, or service, may be in response to a parsed first identifier associated with the statistic matching a second identifier associated with the content item. In some implementations, the parsed first identifier may be a domain name associated with the statistic and the second identifier may be a domain name contained in a link URL of the content item. In further implementations, the parsed first identifier may be a product name associated with the statistic and the second identifier is a product name associated with the content item. In still further implementations, the parsed first identifier may be a resource, such as a website or landing page, and the second identifier may be a website or landing page of a link URL of the content item. In further implementations, the parsed first identifier may be a brand name and the second identifier may be brand name associated with the content item. In further implementations, the parsed first identifier may be a service and the second identifier may be service associated with the content item.

The process 500 may further include receiving a request for a content item from a client device (block 508). The received request may be received from a resource server, a client device, and/or any other computing device. In some implementations, the content item request may include device information, resource information, a query, and/or other information for the content item request.

The process 500 includes selecting the content item associated with the statistic in response to the request (block 510). The content item associated with the statistic may be selected based on an auction performed by a content item selection module of a content item selection system. Values, such as scores, may be determined for each content item based, at least in part, on a quality score for each content item and a bid for each content item. The content items in the auction may be ranked based on a corresponding value for the content item. In some implementations, the content item with the highest value or score may be selected as the content item that wins the auction. In some implementations, a ranking of a content item may be modified based, at least in part, on a statistic for the content item. That is, a statistic for one or more content items in the auction may be determined and a content item selection module may use the statistic for each content item to determine a value or score. Thus, a content item having a high value for a statistic, such as a statistic of 88% for consumer satisfaction, may have a ranking modified by an increase in a resulting score while a content item having a lower value for a statistic, such as a statistic of 54% for consumer satisfaction, may have a ranking modified by a decrease in a resulting score. Thus, in some implementations, the statistic may be retrieved and used by the content item selection module during the auction to modify a ranking of a content item.

The process 500 further includes serving data to effect presentation of the selected content item and data to effect presentation of an annotation based, at least in part, on the statistic (block 512). The data to effect presentation of the selected content item and the data to effect presentation of the annotation may be transmitted via a network to a client device to be displayed with a resource, such as a webpage, on a display of a client device.

In some implementations, the process 500 may include serving a survey to the client device concerning the subject (block 514). The serving of the survey concerning the subject or entity, such as at least one resource, brand, product, or service, may be served to a client device after the client device has been served data to effect presentation of a content item with an annotation for the subject or entity, such as the resource, brand, product, or service. Data received from the client device in response to the served survey concerning the at least one resource, brand, product, or service may be used to update one or more statistics of the statistical data. In some implementations, the annotation for a content item may automatically update, such as through the use of a pointer to the now-updated statistic of the updated statistical data. In some implementations, an annotation generation module may be configured to generate an updated annotation based, at least in part, on the updated statistic.

In some implementations, data may be received from the client device in response to the served survey concerning the subject, such as the resource, brand, product, or service, and updated statistical data may be determined concerning the subject, such as the resource, brand, product, or service, based, at least in part, on the received data from the client device (indicated by the dashed line returning to block 504). The updated statistical data may be determined by parsing the updated statistical data for a first identifier, and matching the parsed first identifier with a second identifier associated with a content item associated with the subject. In some implementations, a second request for a content item may be received from a second client device. The second client device may be the same as the prior client device or a different client device. The content item associated with an updated statistic of the updated statistical data may be selected in response to the request and data to effect presentation of the selected content item and data to effect presentation of an updated annotation with the selected content item may be served to a client device. The updated annotation may be based, at least in part, on the updated statistic of the updated statistical data.

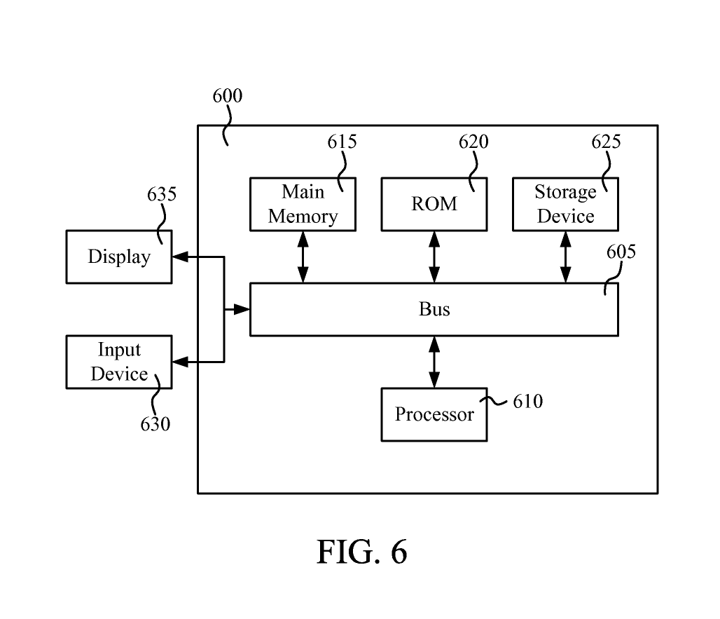

FIG. 6 is a block diagram of a computer system 600 that can be used to implement the client device 110, content item selection system 108, third-party content server 102, resource server 104, etc. The computing system 600 includes a bus 605 or other communication component for communicating information and a processor 610 coupled to the bus 605 for processing information. The computing system 600 can also include one or more processors 610 coupled to the bus for processing information. The computing system 600 also includes main memory 615, such as a RAM or other dynamic storage device, coupled to the bus 605 for storing information, and instructions to be executed by the processor 610. Main memory 615 can also be used for storing position information, temporary variables, or other intermediate information during execution of instructions by the processor 610. The computing system 600 may further include a ROM 620 or other static storage device coupled to the bus 605 for storing static information and instructions for the processor 610. A storage device 625, such as a solid state device, magnetic disk or optical disk, is coupled to the bus 605 for persistently storing information and instructions. Computing device 600 may include, but is not limited to, digital computers, such as laptops, desktops, workstations, personal digital assistants, servers, blade servers, mainframes, cellular telephones, smart phones, mobile computing devices (e.g., a notepad, e-reader, etc.) etc.

The computing system 600 may be coupled via the bus 605 to a display 635, such as a Liquid Crystal Display (LCD), Thin-Film-Transistor LCD (TFT), an Organic Light Emitting Diode (OLED) display, LED display, Electronic Paper display, Plasma Display Panel (PDP), and/or other display, etc., for displaying information to a user. An input device 630, such as a keyboard including alphanumeric and other keys, may be coupled to the bus 605 for communicating information and command selections to the processor 610. In another implementation, the input device 630 may be integrated with the display 635, such as in a touch screen display. The input device 630 can include a cursor control, such as a mouse, a trackball, or cursor direction keys, for communicating direction information and command selections to the processor 610 and for controlling cursor movement on the display 635.

According to various implementations, the processes and/or methods described herein can be implemented by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes and/or method steps described herein. One or more processors in a multi-processing arrangement may also be employed to execute the instructions contained in main memory 615. In alternative implementations, hard-wired circuitry may be used in place of or in combination with software instructions to effect illustrative implementations. Thus, implementations are not limited to any specific combination of hardware circuitry and software.

Although an implementation of a computing system 600 has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The terms “data processing apparatus,” “computing device,” or “processing circuit” encompass all kinds of apparatus, devices, and machines for processing data, including by way of example a programmable processor, a computer, a system on a chip, or multiple ones, a portion of a programmed processor, or combinations of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products embodied on tangible media.

References to “or” may be construed as inclusive so that any terms described using “or” may indicate any of a single, more than one, and all of the described terms.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

What is claimed is:

1. A system for annotating a content item, the system comprising:
one or more processors; and a storage device storing instructions that, when executed by the one or more processors, cause the one or more processors to perform operations comprising:
receiving data from a plurality of users in response to a survey concerning at least one of a resource, a brand, a product, or a service,
determining statistical data concerning the at least one resource, brand, product, or service,
automatically associating a statistic of the statistical data with a content item associated with the at least one resource, brand, product, or service,
receiving a request for a content item from a client device,
selecting the content item associated with the statistic of the statistical data in response to the request, and
serving data to effect presentation of the selected content item and data to effect presentation of an annotation with the selected content item, the annotation based, at least in part, on the statistic of the statistical data.

2. The system of claim 1, wherein the storage device stores instructions that cause the one or more processors to perform operations further comprising:
parsing the statistical data for a first identifier associated with the statistic,
wherein the automatic associating of the statistic of the statistical data with the content item associated with the at least one resource, brand, product, or service is in response to the parsed first identifier associated with the statistic matching a second identifier associated with the content item.

3. The system of claim 2, wherein the second identifier is a domain name contained in a link URL of the content item.

4. The system of claim 2, wherein the second identifier is a product name associated with the content item.

5. The system of claim 1, wherein the storage device stores instructions that cause the one or more processors to perform operations further comprising:
serving the survey concerning the at least one resource, brand, product, or service to a client device of a user of the plurality of users.

6. The system of claim 1, wherein the statistic is a percentage of all users surveyed.

7. The system of claim 1, wherein the statistic is further based on an attribute concerning the at least one resource, brand, product, or service.

8. The system of claim 1, wherein the storage device stores instructions that cause the one or more processors to perform operations further comprising:
modifying a ranking of the content item associated with the statistic of the statistical data based, at least in part, on the statistic.

9. A method for annotating a content item, the method comprising:
determining, using one or more processors, statistical data concerning at least one of a resource, a brand, a product, or a service based on data from a plurality of users in response to a survey concerning the at least one resource, brand, product, or service, wherein the determining of the statistical data includes:
parsing, using one or more processors, the statistical data for a first identifier, and
matching, using one or more processors, the parsed first identifier with a second identifier associated with a content item associated with the at least one resource, brand, product, or service;
associating, using one or more processors, a statistic of the statistical data associated with the first identifier with the content item associated with the at least one resource, brand, product, or service in response to the matched parsed first identifier and the second identifier;
receiving, at one or more processors, a request for a content item from a client device;
selecting, using one or more processors, the content item associated with the statistic of the statistical data in response to the request; and
serving, using one or more processors, data to effect presentation of the selected content item and data to effect presentation of an annotation with the selected content item, the annotation based, at least in part, on the statistic of the statistical data.

10. The method of claim 9, wherein the second identifier is a domain name contained in a link URL of the content item.

11. The method of claim 9, wherein the first identifier is a product name and the second identifier is a product name associated with the content item.

12. The method of claim 9, wherein the statistic is further based on an attribute concerning the at least one resource, brand, product, or service.

13. The method of claim 12, wherein the attribute is associated with a user behavior.

14. The method of claim 9 further comprising:
modifying, using one or more processors, a ranking of the content item associated with the statistic of the statistical data based, at least in part, on the statistic.

15. A computer readable storage device storing instructions that, when executed by one or more processors, cause the one or more processors to perform operations comprising:
determining statistical data concerning at least one of a resource, a brand, a product, or a service based on data from a plurality of users in response to a survey concerning the at least one resource, brand, product, or service, wherein the determining of the statistical data includes:
parsing the statistical data for a first identifier, and
matching the parsed first identifier with a second identifier associated with a content item associated with the at least one resource, brand, product, or service;
associating a statistic of the statistical data associated with the first identifier with the content item associated with the at least one resource, brand, product, or service in response to the matched parsed first identifier and the second identifier;
receiving a request for a content item from a client device;
selecting the content item associated with the statistic of the statistical data in response to the request;
serving data to effect presentation of the selected content item and data to effect presentation of an annotation with the selected content item, the annotation based, at least in part, on the statistic of the statistical data; and
serving the survey concerning the at least one resource, brand, product, or service to the client device.

16. The computer-readable medium of claim 15 storing instructions that cause the one or more processors to perform operations further comprising:
receiving data from the client device in response to the served survey concerning the at least one resource, brand, product, or service; and
determining updated statistical data concerning the at least one resource, brand, product, or service based, at least in part, on the received data from the client device.

17. The computer-readable medium of claim 16 storing instructions that cause the one or more processors to perform operations further comprising:
receiving a second request for a content item from a second client device;
selecting the content item associated with an updated statistic of the updated statistical data in response to the request; and
serving data to effect presentation of the selected content item and data to effect presentation of an updated annotation with the selected content item, the updated annotation based, at least in part, on the updated statistic of the updated statistical data.

18. The computer-readable medium of claim 15, wherein the second identifier is a domain name contained in a link URL of the content item.

19. The computer-readable medium of claim 15, wherein the first identifier is a product name and the second identifier is a product name associated with the content item.

20. The computer-readable medium of claim 15, wherein the statistic is further based on a future user behavior concerning the at least one resource, brand, product, or service.
